(19) United States
(12) Patent Application Publication
(10) Pub. No.: US 2025/0201895 A1
(43) Pub. Date: Jun. 19, 2025

(54) CELL-STACKING SYSTEM FOR STACKING SEGMENTS OF ENERGY CELLS, METHOD FOR CONTROLLING SUCH A CELL-STACKING SYSTEM, SUB-DEVICE OF OR IN A CELL-STACKING SYSTEM, AND SUB-METHOD IN THE PRODUCTION OF CELL STACKS IN A CELL-STACKING SYSTEM

(71) Applicant: KÖRBER TECHNOLOGIES GMBH, HAMBURG (DE)

(72) Inventors: Jan KREYSERN, HAMBURG (DE); Karsten MEINKE, MÖLLN (DE); Dirk ZEUNER, SCHWARZENBEK (DE)

(21) Appl. No.: 18/844,298

(22) PCT Filed: Mar. 7, 2023
(86) PCT No.: PCT/EP2023/055741

§ 371 Date: Sep. 5, 2024

(30) Foreign Application Priority Data
Mar. 8, 2022 (DE) 10 2022 105 399.7

(51) Int. Cl. H01M 10/04; H01M 8/2404

(52) U.S. Cl. CPC H01M 10/0404; H01M 8/2404; H01M 10/0413

(57) ABSTRACT

The invention relates to a cell-stacking system for stacking segments of energy cells, said system comprising: —a feed device which continuously feeds the segments at a feed speed, and —at least one cell-stacking unit which receives the segments from the feed device and stacks said segments one on top of the other to form stacks, wherein —the cell-stacking unit has at least one removal device and one depositing element, wherein —the removal device is driven to perform a repeating alternating movement consisting of an acceleration and a deceleration, and —the removal device receives the segments at the feed speed from the feed device and transfers said segments in a decelerated movement or at a standstill to the depositing element.

The present invention relates to a cell-stacking system having the features of the preamble of claim 1 or claim 16, to a method for controlling such a cell-stacking system having the features of the preamble of claim 23, to a sub-device of or in a cell-stacking system having the features of the preamble of claim 35, and to a sub-method in the production of cell stacks in a cell-stacking system having the features of the preamble of claim 39.

Energy cells or energy stores within the meaning of the invention are used, for example, in motor vehicles, other land vehicles, ships, aircraft or in stationary systems such as photovoltaic systems in the form of battery cells or fuel cells, in which very large amounts of energy have to be stored for long periods of time. For this purpose, such energy cells have a structure consisting of a plurality of segments stacked to form a stack. These segments are alternating anode sheets and cathode sheets, which are separated from each other by separator sheets which are also manufactured as segments. The segments are pre-cut in the production process and then placed on top of each other in the predetermined sequence to form the stacks and joined together by lamination. The anode sheets and cathode sheets are first cut from a continuous web and then placed individually at intervals on a continuous web of separator material. This subsequently formed “two-ply” continuous web made of the separator material with the anode sheets or cathode sheets placed on top is then cut into segments again in a second step using a cutting device, wherein the segments in this case are formed in a double layer by a separator sheet with an anode sheet or cathode sheet arranged on top. Where technically feasible or necessary from a manufacturing perspective, the continuous webs of separator material with the anode sheets and cathode sheets placed on top of them can also be placed on top of one another before cutting, so that a continuous web is formed with a first endless layer of separator material with anode sheets or cathode sheets placed thereon and a second endless layer of separator material with anode sheets or cathode sheets placed thereon. This “four-ply” continuous web is then cut into segments by means of a cutting device, which segments are in this case formed in four layers with a first separator sheet, an anode sheet, a second separator sheet and a cathode sheet lying thereon. Alternatively, the segments can also be formed from a first separator sheet, a cathode sheet, a second separator sheet and an anode sheet lying thereon. The advantage of this solution is that one cut can be saved. Segments within the meaning of this invention are therefore single-ply segments of a separator material, anode material or cathode material, double-ply, triple-ply or four-ply segments of the structure described above.

Devices for producing battery cells are known, for example, from WO 2016/041713 A1 and DE 10 2017 216 213 A1.

Nowadays, the production of battery cells, for example for electromobility, is carried out on production lines with a capacity of 100 to 240 monocells per minute. These work in sub-areas or continuously with clocked discontinuous movements, such as back-and-forth movements and are therefore limited in terms of production capacity. Most known machines operate using the single-sheet stacking method (e.g. “pick and place”) with the disadvantage of slower processing. Laminating cell formations is not possible here.

Another well-known approach involves a machine having continuously running material webs and clocked tools, such as cutting blades or tools for adjusting divisions.

In principle, machines with clocked movements are limited in terms of performance. The parts with mass, such as receptacles and tools, must be constantly accelerated and decelerated. The processes determine the timing and a great deal of energy is consumed. The mass of the moving parts cannot be reduced arbitrarily. Faster moving parts often have to endure higher loads and therefore become more complex and heavier.

In order to reduce the production costs of battery manufacturing, the production capacity of the machines must be increased, among other things. A prerequisite for the high production output is a high production rate of the stacks of energy cells, which are formed from a plurality of segments of the type described above and which are stacked on top of each other.

In an upstream production step, the segments are placed one on top of the other to form what are known as monocells, which consist of a first separator sheet, an anode sheet arranged thereon, a second separator sheet arranged thereon, and a cathode sheet arranged thereon. Alternatively, the separator sheets can be initially guided as two continuous webs, wherein the already cut segments in the form of the anode sheets are placed on one of the continuous webs and the already cut segments in the form of the cathode sheets are placed on the other continuous web and joined together by a lamination process. The composite webs thus prefabricated are then bonded together in a further lamination process to form a four-ply composite web. In principle, it is also possible to place the first cut electrode in the form of the cathode or anode between the separator sheets in the form of the continuous webs and to place the second cut electrode in the form of the anode or cathode on or under one of the separator sheets. The four-ply web is then laminated in a combined lamination process, so that the monocell is produced in a fixed formation while the continuous webs still remain, i.e. before cutting. The monocells are then cut from the composite web by cutting through the spaces between the successive anode sheets and/or cathode sheets. Alternatively, the continuous webs of separator material with the anode sheets and cathode sheets arranged thereon can also be cut, wherein the monocells are then produced by means of a downstream bonding process of a first cut separator sheet with an anode to a second cut separator sheet with a cathode.

The segments are then stacked on top of each other to produce a stack of a plurality of segments. If the segments are monocells or separator sheets with anode or cathode sheets arranged thereon, a cathode or anode will be located on a free side surface of the stack, which is then covered by the arrangement of what is known as a closing cell. The closing cell comprises a first separator sheet, an anode or cathode sheet arranged thereon and a second separator sheet arranged thereon, on which, however, no cathode or anode sheet is arranged. This means that the closing cell can also be regarded as a monocell without a cathode or anode sheet. The finished stack formed from the plurality of monocells and the closing cell is then characterised in that it has one separator sheet in each case on its top side and on its underside, and thus the anode sheets and cathode sheets are each covered on the top side and on the underside by separator sheets and are not in contact with each other.

In order to achieve very high production rates of energy cells and/or energy stores, it is desirable to stack the produced segments at the highest possible production rate with the highest possible positional accuracy.

Against this background, the object of the invention is to provide a cell-stacking system, a method for controlling such a cell-stacking system, a sub-device and a sub-method, which should allow stacking of the segments at the highest possible production rate without this having an adverse effect on the positional accuracy of the stacked segments relative to one another.

To achieve the object, a cell-stacking system having the features of claim 1 or 16 and a method for controlling a cell-stacking system having the features of claim 23 are proposed. Furthermore, to achieve the object, a sub-device according to claim 35 and a sub-method according to claim 39 are proposed. Further preferred developments of the invention can be found in the dependent claims, the figures, and the associated description.

According to claim 1, to achieve the object, a cell-stacking system for stacking segments of energy cells is proposed, comprising
a feed device which continuously feeds the segments at a feed speed, and
at least one cell-stacking unit which indirectly or directly receives the segments supplied by the feed device and stacks them one on top of the other to form stacks, wherein
the cell-stacking unit comprises at least one removal device and one depositing element, in which
the removal device is driven to perform a repeating alternating movement consisting of an acceleration and a deceleration, and
the removal device receives the segments at the feed speed from the feed device and transfers said segments in a decelerated movement or at a standstill to the depositing element.

The advantage of the proposed solution is that the segments are received by the removal device at the feed speed of the feed device and are then transferred to the depositing element at a lower speed or even at a standstill by decelerating the movement of the removal device. As a result of this, by receiving the segments at the feed speed of the feed device, an uninterrupted removal of the segments from the feed device at a high transport speed can be achieved with the lowest possible load on the segments during receiving. On the other hand, by decelerating the removal device or stopping the removal device, the segments can be transferred to the depositing element with lower transverse forces acting on the segments. In this case, the reduced transverse forces when the segments are delivered to the depositing element are of particular importance because it allows the segments to be stacked in the depositing element with greater positional accuracy. In this way, abrasive relative movements between a segment which has already been deposited and the segment which is currently in the depositing movement can be minimized.

It is further proposed that the removal device is formed by a rotatably driven rotary body, and the repeating alternating movement consisting of an acceleration and a deceleration is formed by an accelerated and decelerated rotary movement of the rotary body. The realization of the removal device as a rotatably driven rotary body has the advantage of a very high receiving speed of the segments from the removal device in a continuous feeding movement. Furthermore, the use of the rotatably driven rotary body has the advantage of a very compact design of the cell-stacking system. Furthermore, a series of cylinders in the form of a plurality of cylinders connected one after the other can be used as a feed device, which series of cylinders allows the segments to be fed at a very high feed rate.

It is further proposed that the rotary body has at least one, preferably two, three or more than three receiving dogs arranged at identical angles to one another for receiving the segments, and that the rotary body is decelerated and accelerated during one revolution according to the number of receiving dogs. Due to the plurality of receiving dogs, the receiving rate of the segments by the rotary body can be increased and/or, conversely, the required rotational speed of the rotary body can be reduced for a given number of segments to be received per unit of time.

According to a further preferred development, it is proposed that the number of receiving dogs is odd. As a result, the receiving station of the segments from the feed device and the transfer station to the depositing element can be arranged opposite one another, i.e. at an angle of 180 degrees in relation to the axis of rotation of the cylinder, and there is no other receiving dog in the transfer station if a receiving dog is arranged in the receiving station. The same applies to the opposite case. The proposed further development allows the receiving station and the transfer station to be arranged opposite one another, which allows a structurally simple design of the cell-stacking system without two receiving dogs passing through the receiving station and the transfer station at the same time.

It is further proposed that the receiving dogs each have a circular-arcuate receiving surface in the cross-section of the rotary body, and that the receiving surfaces of the receiving dogs are arranged on the same diameter in the cross-section. The receiving surfaces of the receiving dogs thus form a receiving radius and pass through the receiving station and transfer station on an identical diameter in relation to the rotary body.

It is further proposed that the depositing element has a linearly movable receptacle which transports the stacks away from the removal device in the direction of the surface normal of the segments. By means of the receptacle which can be moved linearly in the proposed direction, the stacks and/or the segments stacked therein are transported away without any transverse forces acting on them. This prevents the segments and/or stacks from losing their positionally accurate arrangement while being transported away.

It is further proposed that the depositing element has a lifting device which, when activated, moves the receptacle via a linear guidance device. The linear guidance device and the associated lifting device transport the receptacle and the stack held therein away along a predetermined travel path. The receptacle can thus be brought back into the transfer station of the removal device in a very precisely controlled movement after the stack has been delivered.

In this case, it is further proposed that at least one sensor device is provided in the region of the lifting device, which sensor device detects a property of the stack or of the receptacle. The travel path of the receptacle realized by the lifting device can thus also be used for the arrangement of a sensor device. The guidance device defines the travel path of the receptacle and allows precise alignment of the sensor device in relation to the receptacle moving past it with the stack held therein. In this case, the sensor device can detect, for example, the position of the receptacle or the passage of the receptacle through a predetermined position. Furthermore, properties of the stack such as the stack height, the side surfaces of the stack or the arrangement and orientation of the stack can be detected so that these can be documented or faulty stacks can be outwardly transferred before further processing.

It is further proposed that the depositing element has a transfer device which can be moved from a ready position to a holding position. The transfer device is arranged in the holding position while the receptacle is being moved to transport the stack away and forms a temporary depository for deposition of the segments. The transfer device provided allows the segments to be deposited even when the receptacle filled with the previously completed stack is moved from the removal device to a delivery location for transferring the stack and is thus not available to receive the segments in the transfer position of the removal device. As a result, uninterrupted, i.e. continuous, delivery of the segments from the removal device to the depositing element can be made possible at a high stacking rate. To ensure that the segments are deposited on the transfer device only when the receptacle is not arranged in the transfer position of the removal device, the transfer device is moved from the holding position back to the ready position as soon as the receptacle has been moved back to the transfer station of the removal device. This means that the stacking process and in particular the movement of the receptacle out of the transfer station is not disturbed or restricted by the transfer device. The transfer device is then moved from the ready position to the holding position when a predetermined number of segments are stacked in the receptacle and/or when a predetermined stack height is reached, namely immediately after the last segment is deposited on the stack. In this case, the transfer device is moved into the deposition path of the segments so that the deposition of the next segment on the stack is interrupted and the next segment is deposited on the transfer device instead. The transfer device thus effectively takes over the function of the receptacle for a short time by forming a temporary depository until the receptacle is moved back to the transfer station.

It is further proposed that the receptacle and the transfer device each have a setdown surface which is formed by the surfaces of profiles made of fins and intermediate spaces arranged therebetween, wherein the transfer device and the receptacle engage with their fins in the intermediate spaces of the other part during their movements for transferring the stacks of segments. Due to the proposed design of the setdown surfaces, the receptacle can be moved back to the transfer station after the stack has been delivered without thereby colliding with the transfer device. In this case, when moving to the transfer station, the receptacle is moved with the fins of its setdown surface between the fins of the setdown surface of the transfer device and thus complements the setdown surface of the transfer device to form an enlarged receiving surface. After the receptacle is back in the transfer station, the transfer device is moved from the holding position back to the ready position and transfers the already stacked segments to the receptacle. The stack is essentially “relocated” and transferred from the temporary depository on the transfer device to the receptacle. In this case, the fins can be oriented equidistantly and parallel to each other. Furthermore, the fins can also have different distances and/or a different orientation if the transfer and receiving of the segments and in particular the engagement movement require it.

It is further proposed that a discharge device be provided with a plurality of individually movable transport receptacles into which the depositing element deposits the stacks. The individually movable transport receptacles are used to transport the stacks away for further processing. Because the segments and stacks are checked for compliance with predetermined quality criteria by means of one or more sensor devices during the preceding transport and/or stacking process and are outwardly transferred from the production process if the quality criteria are not met, the stacking processes and the frequency of the stacks to be transported away can vary. This change in the transport frequency of the stacks to be transported away can be taken into account by the individual mobility of the transport receptacles in conjunction with an appropriate control system.

It is further proposed that the removal device and/or the receptacle of the depositing element have one or more vacuum lines which can be subjected to a negative pressure and which, by the application of negative pressure, support the reception of the segments by the removal device from the feed device and/or by the depositing element from the removal device and also the transport on the removal device. Due to the vacuum lines which can be subjected to a negative pressure, the transfer of the segments and the transport of the segments on the removal device can be achieved with very low forces acting on the segments. Furthermore, the forces exerted on the segments can be easily controlled by switching the negative pressure in the vacuum lines on and off. For example, the reception of the segments by the removal device from the feed device can be controlled very easily by switching on the negative pressure in the vacuum lines of the removal device and switching off the negative pressure in the vacuum lines of the feed device at a transfer point. The transfer of the segments from the removal device to the depositing element is then carried out analogously by switching off the negative pressure in the vacuum lines of the removal device and switching on the negative pressure in the vacuum lines of the receptacle of the depositing element. In a further embodiment, a holding vacuum is applied to one or each vacuum line of the removal device which opens into a carrier zone, which holding vacuum is switched off with a delay during or at the time of transfer of the segment to the depositing element and a segment to be transferred is drawn against the holding vacuum which is still at least partially applied, which ensures that the segment to be transferred is held in a fixed, positionally accurate manner and helps prevent position changes due to any floating or falling movements.

Furthermore, to achieve the object, a cell-stacking system having the features of the preamble of claim 16 is proposed, wherein at least one cell-stacking unit is arranged in the cell-stacking device, which cell-stacking unit stacks the segments one on top of the other to form stacks, wherein the cell-stacking unit has at least one removal device and a depositing element arranged at a transfer station, and the removal device has a rotary body which can be driven to rotate and has at least two carrier zones which are arranged at a distance from one another in the direction of rotation (and fixed in the direction of rotation) and extend in the direction of rotation over a length Y for receiving the segments at a receiving station.

The proposed solution allows the segments to be stacked at a very high rate in that the removal device, due to its design as a rotary body having carrier zones and free zones, receives the segments in a continuous rotational movement over the carrier zones in the transfer station.

The length Y of one or each carrier zone extending in the direction of rotation is greater than or equal to 20 mm, 50 mm, 60 mm, 90 mm or 100 mm. The length Y of one or each carrier zone extending in the direction of rotation is less than or equal to 200 mm, 180 mm, 150 mm, 120 mm, 100 mm, 80 mm or 60 mm. The extension of one or each carrier zone transverse to the length Y is greater than or equal to 40 mm, 50 mm, 60 mm, 80 mm, 90 mm, 100 mm, 150 mm, 180 mm or 300 mm. The extension of one or each carrier zone transverse to the length Y is less than or equal to 400 mm, 350 mm, 300 mm, 250 mm, 200 mm, 150 mm, 130 mm, 120 mm, 110 mm, 100 mm, 90 mm, 80 mm, 50 mm or 40 mm.

In this case, free zones are preferably provided between the carrier zones, extending in the direction of rotation over a length Z, wherein the carrier zones and the free zones are arranged in such a way that the removal device passes the depositing element with a free zone in a receiving phase at the receiving station during which a segment is received by a carrier zone.

The free zones are deliberately designed not to receive segments and allow the transfer station to be passed while a segment is being received in the receiving station, without a segment being delivered in the transfer station.

The advantage of the proposed solution is that the proposed design of the cell-stacking device allows for improved reception and transfer of the segments and thus an improved segment stacking. Because the segments are not simultaneously received and transferred in a single position of the removal device due to the proposed carrier zones, free zones and their arrangement, the removal device can be optimized in its movement behaviour when receiving and transferring the segments in order to optimize an improved reception of the segments from the feed and an optimized delivery and stacking of the segments by individually designing its movement behaviour accordingly in the positions in which it passes the transfer station and the receiving station with the carrier zones.

It is further proposed that the length Y of one or each carrier zone be less than, equal to or greater than the length Z of one or each free zone. If the length Y of the carrier zone is smaller, this is advantageous for the transfer of the segments because in this case the greater length of the free zone means that a larger angle of rotation is available for adjusting the movement behaviour of the removal device until the segment is received and transferred. If the length Y of the carrier zones is equal to the length Z of one or each free zone, the advantage of a change in the movement behaviour which is as uniform as possible can be achieved, in particular with identical accelerations and decelerations of the removal device. If the length Y of the carrier zones is greater than the length Z of the free zones, this is advantageous with regard to the capacity of the removal device because the lateral surface of the rotary body can be designed to receive and transfer a greater number of segments.

It is further proposed that the lengths Z of the free zones between the carrier zones be equal or different. If the length Z of the free zones is the same, it will be possible to realize repeating movements of the rotary body between the reception and the transfer of a segment and vice versa which are as similar as possible. If the length Z of the free zones is different, this will allow individually different movement processes to be realized, whereby, for example, deviations in the feed movements or the discharge movements of the segments can be taken into account.

It is further proposed that one or each carrier zone have a receiving surface. The receiving surface allows the segments to be held flat on the carrier zones and transported from the receiving station to the transfer station by the rotary body. This allows particularly gentle transport of the segments with the lowest possible local area-related maximum forces acting on the segments.

It is further proposed that one or each free zone is formed by a radially inwardly extending recess on the rotary body. The proposed design of the free zones creates free spaces on the rotary body, which free spaces allow for a collision-free overlapping relative movement, for example, of the depositing element or on the feed device with respect to the rotary body. In addition, this can reduce the mass of the rotary body to be moved, which in turn simplifies motion control and reduces the energy required to drive the rotary body.

It is further proposed that one or each free zone has a boundary offset radially inwardly relative to one or each carrier zone. The radially inwardly offset boundary creates a clearly defined spatial separation of the free zone from the carrier zone, which allows, for example, simplified detection of the rotational movement of the rotary body.

Furthermore, to achieve the object, a method for controlling a cell-stacking system for stacking segments of energy cells according to claim 23 is proposed, comprising
a feed device which continuously feeds the segments at a feed speed, and
at least one cell-stacking device which receives the segments from the feed device and stacks them one on top of the other to form stacks, wherein
the cell-stacking device has at least one removal device and one depositing element, in which
the removal device has a controllable drive device which is controlled such that the removal device is accelerated to receive the segments from the feed device and is decelerated to transfer the segments to the depositing element.

The advantage of the proposed method is that the segments are received by the removal device at the feed speed of the feed device in a continuous feed and are then transferred to the depositing element for stacking the segments at a lower speed or even at a standstill by decelerating the movement of the removal device. As a result of this, by receiving the segments at the feed speed of the feed device, an uninterrupted removal of the segments from the feed device at a high transport speed can be achieved with the lowest possible load on the segments during reception. On the other hand, by decelerating the removal device or stopping the removal device, the segments can be transferred to the depositing element with lower transverse forces acting on the segments. In this case, the reduced transverse forces when the segments are delivered to the depositing element are of particular importance because this allows the segments to be stacked in the depositing element with greater positional accuracy. Due to the proposed control, the cell-stacking system forms an interface between the continuous feeding of the segments via the feed device and the stacking of the segments, which takes place at a lower transverse speed or ideally without any transverse speed of the segments, i.e. without any additional transport speed.

It is further proposed that the removal device is formed by a cylinder driven by the drive device to perform a rotational movement, and that the drive device controls the rotational movement of the cylinder in such a way that the cylinder receives the segments from the feed device in a rotational movement and transfers them to the depositing element when at a standstill or in a decelerated rotational movement. By designing the removal device as a rotatably driven cylinder, the deceleration and acceleration of the removal device can be achieved very easily by decelerating and accelerating the rotational movement of the cylinder, which can be done, for example, by means of a controlled drive via an electric motor. Furthermore, the removal device can thereby be specially designed to receive the segments from a feed device formed by a series of cylinders.

It is further proposed that the removal device and/or the depositing lever each have vacuum lines which hold the segments on the removal device and/or the depositing lever by applying a negative pressure, and that the negative pressure in the vacuum lines of the removal device and in the vacuum lines of the depositing lever for transferring the segments is controlled in an overlapping manner. Due to the overlapping application of the negative pressure in the vacuum lines of the removal device and of the depositing lever, the segments are continuously subjected to a suction force by the application of a negative pressure during the transfer, such that they cannot carry out any uncontrolled movements. The segments are held on the removal device by the negative pressure in the vacuum lines until the depositing lever, with its vacuum lines under negative pressure, also contacts the segments with a negative pressure and receives the segments. The negative pressure in the vacuum lines of the removal device is practically only switched off when the segments have been actively received by the depositing lever through the negative pressure in the vacuum lines of the depositing lever. The negative pressure in the vacuum lines of the removal device is preferably applied long enough for the depositing lever to pull the segments off the removal device against a residual holding force. The segments are therefore not transferred at any stage without controlled forces being exerted on the segment. The movement of the segment is thus controlled in every movement phase by the movement of the removal device, of the depositing lever by the applied negative pressure, and the segment cannot carry out any uncontrolled movements.

It is further proposed that the depositing element have a linearly movable receptacle, and that the linearly movable receptacle is moved from a receiving position to a delivery position when a sensor device detects that a predetermined stack height of the stack in the receptacle has been reached. The receptacle is used to transport the finished stack from the receiving position to the delivery position and is moved linearly to ensure that the forces acting on the segments are as low as possible.

It is further proposed that a transfer device be provided which is moved from a ready position to a holding position by means of a controllable drive device in order to receive the segments. The transfer device creates a second setdown surface for the segments, which is used as temporary depository in the holding position, while the receptacle is not arranged in the receiving position and/or the transfer station of the removal device.

Between the transfer of two segments the transfer device is preferably moved from the ready position to the holding position. Due to the proposed movement of the transfer device, the transfer device forms a setdown surface for the subsequent segments, and the receptacle can be moved from the receiving position to the delivery position, in which the stack arranged in the receptacle is transferred to the discharge device. The proposed solution provides a virtually uninterrupted setdown surface for the segments, so that the stacking process can be continued even while the receptacle is moving.

It is further proposed that the transfer device be moved from the holding position to the ready position after the movable receptacle has been moved from the delivery position to the receiving position. The movement of the transfer device and of the receptacle also overlap in this phase, so that the transfer device is only moved back to the ready position when the receptacle is in the receiving position and can receive the subsequent segments

It is further proposed that the movement of the transfer device be controlled as a function of the movement and/or the position of the receptacle. This can prevent a collision between the transfer device and the receptacle during their movement sequences. Furthermore, the overlapping movement can be controlled particularly easily by activating the movement of the transfer device to the ready position or the movement of the receptacle to the delivery position only when the other part has completed the previous movement process. To ensure the most effective interaction between the receptacle and the transfer device, the movements of the receptacle and the transfer device are preferably controlled in relation to each other in such a way that at least the receptacle or the transfer device is always arranged in the receiving position and forms a setdown surface for the segments to be deposited. This allows uninterrupted deposition of the segments.

It is further proposed that the receptacle and the transfer device each have a setdown surface which is formed by the surfaces of a plurality of fins arranged parallel to and equidistant from one another, and that the transfer device and the receptacle engage one another with their fins during their movements to transfer the stacks of segments. The proposed further development allows the receptacle to be very easily moved to the receiving position while the transfer device is still in the holding position by inserting the receptacle with its fins between the fins of the transfer device without colliding therewith.

It is further proposed that the depositing element have a depositing lever which removes the segments from the removal device and feeds them to the depositing element. The depositing lever receives the segments from the removal device and actively guides them into the receptacle of the depositing element, such that the transfer of the segments from the removal device to the receptacle is controlled and guided accordingly, wherein the forces acting on the segments during the transfer can also be controlled and minimized by an appropriate course of the discharge movement. Furthermore, the transfer of segments can thereby be made more reliable.

It is further proposed that the depositing lever be driven by a drive device to perform a periodic discharge movement from the removal device. Due to the periodic discharge movement, the segments can be discharged one after the other in an identical discharge movement. Here, the periodic discharge movement is preferably a linear lifting movement with the lowest possible transverse forces acting on the segments.

Furthermore, to achieve the object, a sub-device of or in a cell-stacking system for segments of energy cells according to any of claims 1 to 22 is proposed, in which
the feed device is designed and configured to feed segments of energy cells in a number A per unit of time,
a first conveyor unit for segments is provided, which first conveyor unit is arranged downstream of the feed device,
a second conveyor unit for segments is provided, which second conveyor unit is arranged downstream of the first conveyor unit, wherein
the first conveyor unit is designed and configured to receive the number A per unit of time of the segments from the feed device and to transport a number B per unit of time of the segments to a first delivery area and a number C per unit of time of the segments to a second delivery area, wherein
the number B per unit of time of the segments is provided so as to be transportable in the direction of the second conveyor unit and transferable to the second conveyor unit in the delivery area, and wherein
the number C per unit of time of the segments is provided in the second delivery area so as to be transferable, in particular to a cell-stacking device, or to a cell-stacking unit, or to one or more removal devices of a cell-stacking device, and
in particular, the sum of the number B per unit time of the segments and the number C per unit time of the segments is less than or equal to the number A per unit time of the segments.

Furthermore, to achieve the object, a sub-method for producing cell stacks in a cell-stacking system for segments of energy cells according to any of claims 1 to 22 is proposed, in which
a number per unit of time of segments is fed by means of the feed device, which is designed and configured to feed segments of energy cells in a number A per unit of time,
a first conveyor unit for segments, which is arranged downstream of the feed device, conveys segments,
a second conveyor unit for segments, which is arranged downstream of the first conveyor unit, conveys segments, wherein
the first conveyor unit receives the number A per unit of time of the segments from the feed device and transports a number B per unit of time of the segments to a first delivery area and a number C per unit of time of the segments to a second delivery area G2, wherein
the number B per unit of time of the segments is transported in the direction of the second conveyor unit and transferred to the second conveyor unit in the first delivery area, and wherein
the number C per unit of time of the segments in the second delivery area is transferred, in particular to a cell-stacking device, or to a cell-stacking unit, or to one or more removal devices of a cell-stacking device, and in particular
the sum of the number B per unit time of the segments and the number C per unit time of the segments is less than or equal to the number A per unit time of the segments.

Both the sub-device and the sub-method comprise two conveying units and a division of the supplied segments into two partial streams. If the capacity of the system is to be increased or the number of segments further transported in the partial streams is to be reduced, additional conveyor units arranged parallel or in series with respect to the first two conveyor units can be provided according to the same principle.

It is further proposed that the second conveyor unit be operated as a rotationally drivable conveyor unit, in particular in the form of a transfer cylinder or as an operatively connected combination of a first rotationally drivable conveyor unit, in particular in the form of a reversing cylinder, and a second rotationally drivable conveyor unit, in particular in the form of a transfer cylinder.

The advantage of the proposed sub-device and the proposed sub-method is that the cell-stacking devices and/or removal devices are stacked at a lower stacking rate, corresponding to the smaller numbers B and C, than they are fed in the number A due to the division of the segments supplied in the number A onto the two conveyor units. This allows the conveying rate of the feed device to be designed to be correspondingly high, and at the same time the stacking rate can be designed to be correspondingly low for high positional accuracy of the stacked segments and thus of the stack itself.

In this case, the second conveyor unit is preferably designed as a rotationally drivable conveyor unit, in particular in the form of a transfer cylinder or as an operatively connected combination of a first rotationally drivable conveyor unit, in particular in the form of a reversing cylinder, and a second rotationally drivable conveyor unit, in particular in the form of a transfer cylinder, which make possible very high conveying capacities for the segments on their own. In particular, the design of the first conveyor unit as a rotatably drivable conveyor unit makes possible continuous feeding and discharge of the segments to and from the conveyor unit.

Due to the rotational movement of the conveyor unit, the forces acting on the segments, in particular in the transverse direction, can be reduced to the lowest possible level, which in turn allows the segments to be transported with very high positional accuracy and thus also the formation of very positionally accurate stacks.

The invention is explained below using preferred embodiments with reference to accompanying figures. Shown are:

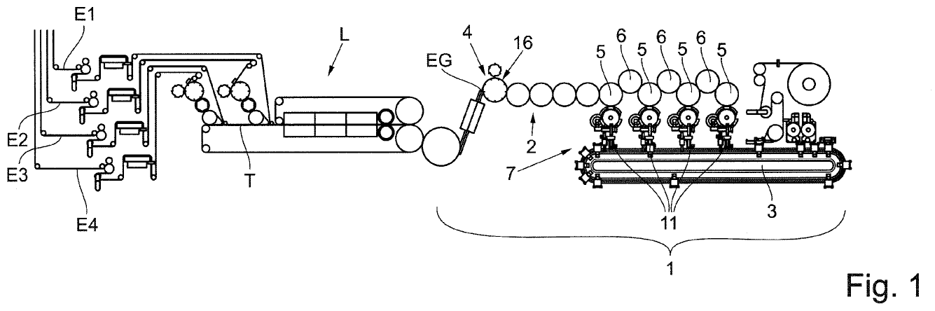

FIG. 1: a production machine with a cell-stacking system according to the invention; and

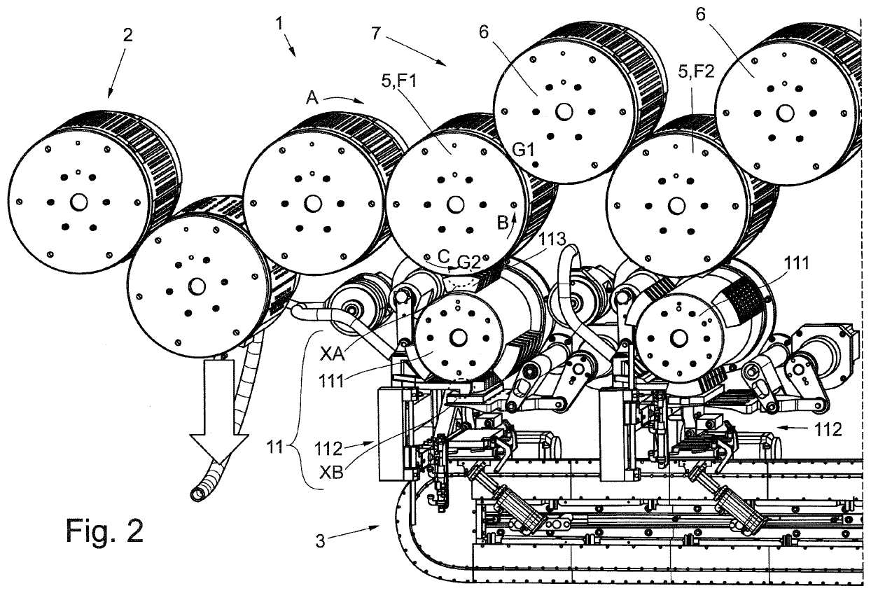

FIG. 2: an enlarged representation of the cell-stacking system with a cell-stacking device and a plurality of cell-stacking units in a perspective view; and

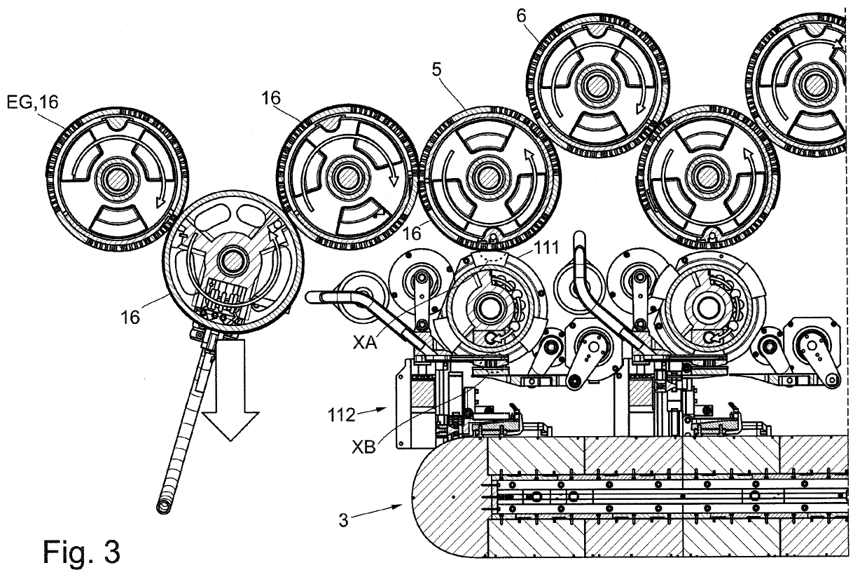

FIG. 3: an enlarged representation of the cell-stacking system in cross-section, with the directions of rotation of the cylinders indicated; and

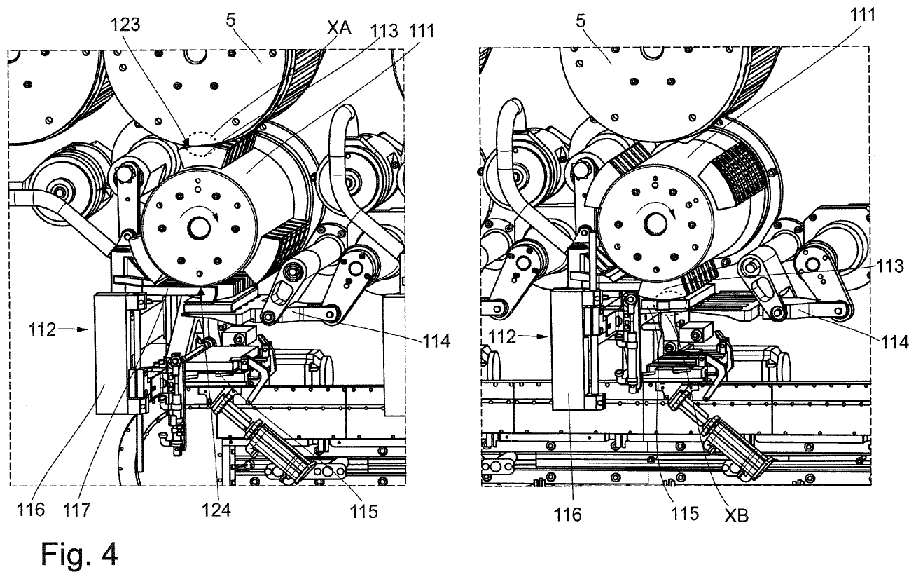

FIG. 4: two representations of a cell-stacking unit with one removal device arranged in a receiving position and one in a transfer position in a perspective view; and

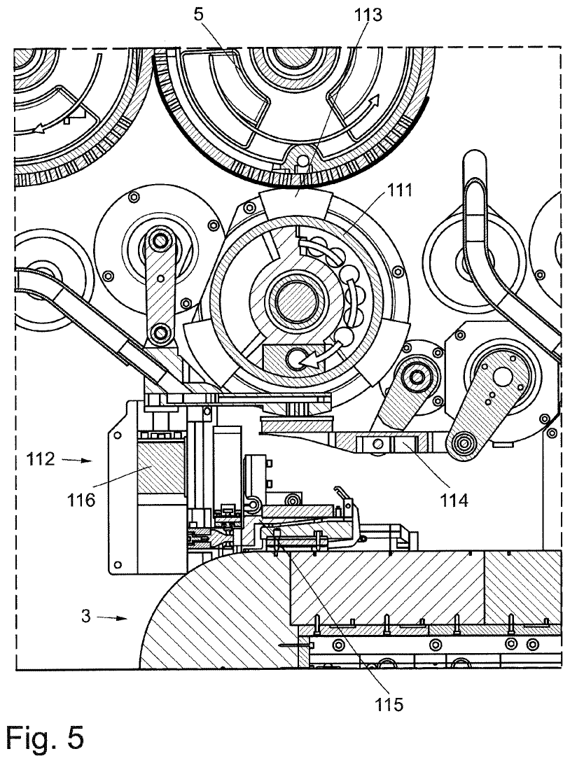

FIG. 5: a removal device in the receiving position with a transfer device in a holding position in a sectional view; and

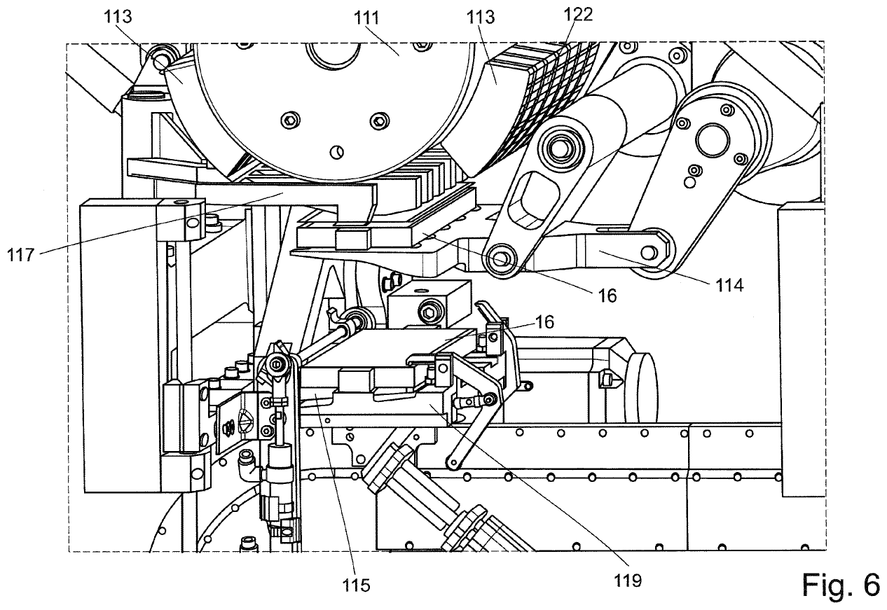

FIG. 6: a removal device in the receiving position with a transfer device in a holding position in a perspective view; and

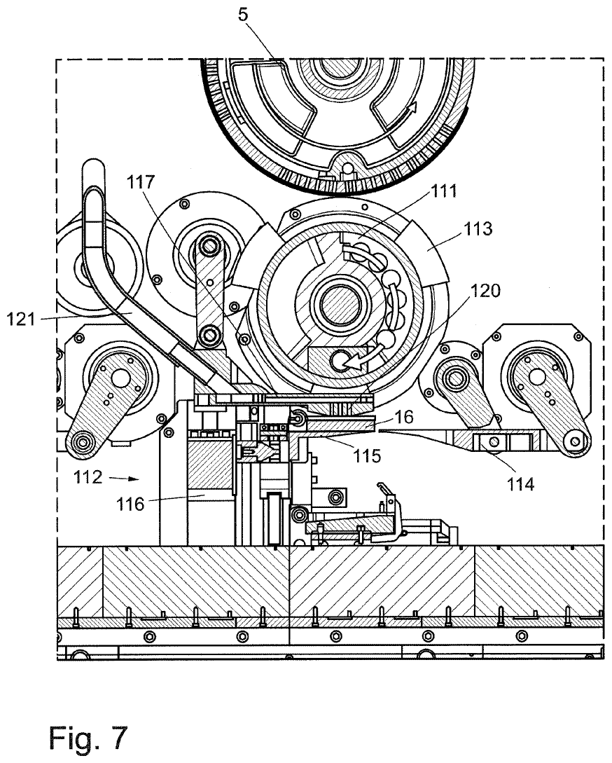

FIG. 7: a removal device in the transfer position with a transfer device in a ready position in a sectional view; and

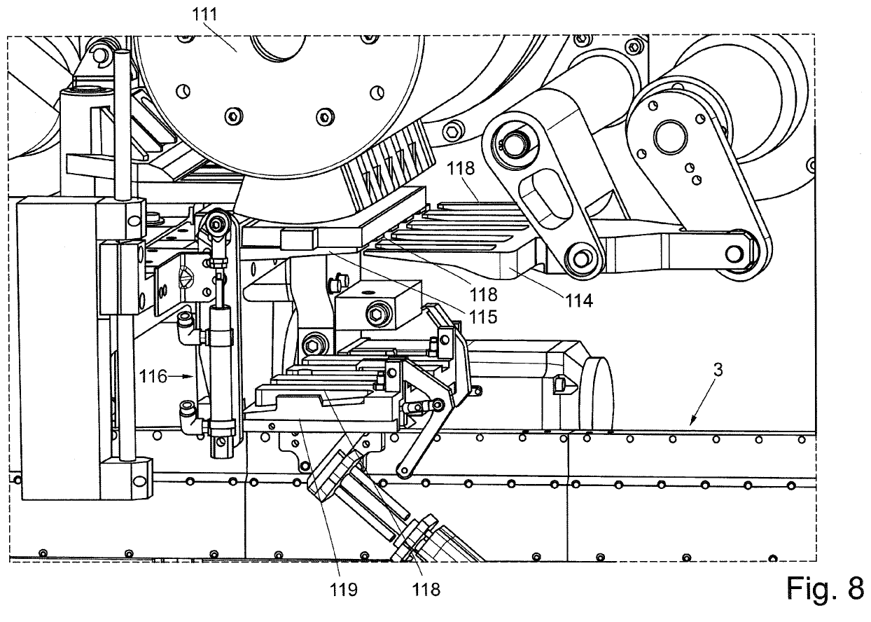

FIG. 8: a removal device in the transfer position with a transfer device in a ready position in a perspective view; and

FIG. 1 shows a production machine having a cell-stacking system 1 according to the invention with a first feed device 2, a discharge device 3, an upstream cutting device 4 and a cell-stacking device 7 arranged between the feed device 2 and the discharge device 3. Furthermore, the production machine comprises a feed of four continuous webs (E1-E4), wherein two of the continuous webs E1 and E3 are formed from a separator material, one continuous web E2 is formed from an anode material and one continuous web E4 is formed from a cathode material. The continuous webs E2 and E4 of the cathode material and the anode material are each cut into anodes and cathodes of a predetermined length and/or width by means of a cutting device, which anodes and cathodes are then placed on one of the continuous webs E1 and E3 of the separator material after cutting. In this case, the combining is carried out by first individually placing the anodes or cathodes cut from the bottom continuous web E4 onto a conveyor belt T, then placing the continuous web E3 of the separator material located thereabove, and then individually placing the anodes or cathodes cut from the continuous web E2 onto the continuous web E3 of the separator material, which anodes or cathodes are then covered on the upper side to form a four-ply continuous web EG by placing the topmost continuous web E1 of the separator material. This four-ply continuous web EG having the anodes or cathodes on an upper side is then fed to a lamination unit L, in which they are bonded together by thermal and/or mechanical energy to form a solid composite. If the four-ply continuous web EG is to have a different structure, the continuous webs E1 to E4 can also be arranged differently.

The laminated four-ply continuous web EG is then fed to the cell-stacking system 1 in the production machine and cut into segments 16 of a predetermined length and/or width in the cutting device 4, which segments are also referred to as monocells. However, it is also conceivable to feed two-ply segments 16 consisting of only one layer of a separator material and an anode or cathode and/or also single-ply segments 16 to the cell-stacking system 1 in the production machine, provided that these are to be further processed in a stacked manner.

Here, the cutting device 4 is formed by a pair of cylinders consisting of a cutting cylinder having cutting blades and a counter-cylinder having counter-blades and cuts the four-ply continuous web EG guided onto the cutting cylinder or the counter-cylinder into segments 16 of a predetermined length by shearing the cutting blades against the counter-blades, which predetermined length is defined by the distances between the cutting blades or the counter-blades, depending on whether the continuous web is guided onto the cutting cylinder or the counter-cylinder. Starting from the cutting device 4, the cut segments 16 are fed to the feed device 2. The feed device 2 is formed by a series of cylinders having a plurality of transport cylinders on which the segments 16 are held, e.g. by a negative pressure. If the fed continuous web is a four-ply continuous web EG, the segments 16 cut therefrom then correspond to the monocells described above.

The cell-stacking system 1 having the cell-stacking device 7 is shown enlarged in FIG. 2. The feed device 2 comprises four transfer cylinders 5 and three reversing cylinders 6 arranged between two transfer cylinders 5 in each case, wherein only two of them can be seen in the detail of FIG. 2. Furthermore, the cell-stacking device 7 comprises four cell-stacking units 11, each of which has a removal device 111 and an associated depositing element 112, of which only two can be seen in the detail of FIG. 2. The removal device 111 is designed as a rotary body, e.g. in the form of a cylinder, which is driven to perform a rotary movement and has three carrier zones in the form of receiving dogs 113 aligned at angles of 120 degrees to each other. The receiving dogs 113 have an outer surface which in its outer dimensions corresponds at least to the outer shape of the segments 16 or can also be larger than these. In their cross-section perpendicular to the axis of rotation of the removal device 111, the receiving dogs 113 have a circular-arcuate contour with in each case identical radii, so that they complement each other to form a virtual circle. Furthermore, the removal devices 111 with their receiving dogs 113 are arranged in such a way and have such radii dimensions that during the rotational movement, the outer surfaces of the receiving dogs 113 are tangential to the lateral surfaces of the transfer cylinder 5 with a gap corresponding at least to the thickness of the segments 16. Here, the rotational movement of the removal device 111 is controlled in relation to the corresponding transfer cylinder 5 in such a way that the receiving dogs 113 each receive exactly one segment 16 from the transfer cylinder 5 during rotation. For this purpose, the movement of the removal device 111 is controlled such that the lateral surfaces of the receiving dogs 113, at the point of the shortest distance from the transfer cylinder 5 corresponding to the transfer station XA, have a circumferential speed corresponding to the circumferential speed of the segments 16 held on the transfer cylinder 5, and the segments 16 are ideally received by the receiving dogs 113 without a relative speed in the circumferential direction.

The lateral surfaces of the receiving dogs 113 have at least one circular arc length in the circumferential direction, which circular arc length corresponds to the width of the segments 16 oriented in the circumferential direction of the transfer cylinder 5, so that the segments 16 are received by the receiving dogs 113 over their entire surface. Furthermore, for this purpose, the receiving dogs 113 also have a length in the axial direction of the removal device 111 which corresponds at least to the length of the segments 16 in the axial direction of the removal cylinder 5. The receiving dogs 113 have a comb-like structure having a plurality of fins parallel to each other and oriented in the circumferential direction, between which fins gaps of constant and identical width are arranged. The end faces of the fins then together form the lateral surfaces of the receiving dogs 113.

The receiving dogs 113 each form a receiving surface 123 on their outer sides, which are separated from each other by free zones 124 due to the plurality of receiving dogs 113.

Vacuum lines 122 are provided in the fins of the receiving dogs 113, which vacuum lines can be subjected to a negative pressure and whose openings open into the end-face lateral surfaces of the fins and/or receiving dogs 113 and can be seen in FIG. 6 and FIG. 4. Furthermore, corresponding openings for vacuum lines which can be subjected to a negative pressure can also be provided in the lateral surfaces of the transfer cylinders 5. The segments 16 are then held on the lateral surfaces of the transfer cylinders 5 by applying a negative pressure in the vacuum lines and are received by the removal device 111 by switching off the negative pressure in the vacuum lines of the transfer cylinder 5 and by switching on the negative pressure in the vacuum lines 122 of the receiving dog 113 passing through the receiving station XA, as can be seen in the left-hand representation of FIG. 4.

The rotational movement of the removal devices 111 and thus of the receiving dogs 113 is controlled such that they receive the segments 16 from the transfer cylinders 5 in a predetermined sequence. In the present exemplary embodiment, four cell-stacking units 11 are provided in the cell-stacking device 7, so that each of the cell-stacking units 11 receives segments 16 from the feed device 2 in a fixed sequence in a four-based rhythm. Thus, the first removal device 111 of the first cell-stacking unit 11, which first removal device is assigned to the first transfer cylinder 5, receives with one of its receiving dogs 113 the first segments 13 of a group of four from the first transfer cylinder 5 in a rhythm during one revolution. The segments 16 of the group of four remaining on the first transfer cylinder 5 are then received by the first reversing cylinder 6 and transferred to the second transfer cylinder 5. Due to the transfer of the segments 16 to the second transfer cylinder 5 via the reversing cylinder 6, the segments 16 are rotated once about their longitudinal axes, which are parallel to the axes of rotation of the transfer cylinder 5 and of the reversing cylinder 6, so that on the second transfer cylinder 5 they are directed outwards with the same upper side as on the first transfer cylinder 5. The second cell-stacking unit 11 then removes the second segments 16 of the group of four from the second transfer cylinder 5 in the same way using the receiving dogs 113 of the second removal device 111, as can be seen in FIG. 2. This process is repeated until finally the fourth cell-stacking unit 11 removes the last segments 16 of the group of four from the fourth transfer cylinder 5 and all segments 16 of the group of four have been received by the cell-stacking units 11. Because each of the removal devices 111 has three receiving dogs 113, the segments 16 are removed from the feeder by the receiving dogs 113 in three groups of four until all segments 16 have been removed after transfer by the last transfer cylinder 5.

FIG. 4 shows a cell-stacking unit 11 according to the invention with a depositing element 112 according to the invention in an enlarged view in two different positions. The removal device 111 is arranged between the transfer cylinder 5 and the depositing element 112 and receives the segments 16 from the transfer cylinder 5 according to the procedure described above. The removal device 111 is driven to rotate in a clockwise direction, as can be seen from the direction of the arrows in FIGS. 3 and 4. During the reception of each of the segments 16, the removal device 111, with one of its receiving dogs 113 in the “12 o'clock position”, passes through the receiving station XA, as can be seen in the left-hand representation of FIG. 4. This position of the removal device 111 with a receiving dog 113 arranged in the “12 o'clock position” is also referred to as the receiving position of the removal device 111 within the meaning of the invention. The receiving dog 113, which has received the segment 16 of the previous group of four from the removal cylinder 5, is in the “4 o'clock position” in this position. In this receiving position, the removal device 111 rotates at a circumferential speed of the lateral surfaces of the receiving dogs 113 corresponding to the circumferential speed of the segments 16 on the transfer cylinder 5 and, with the receiving dog 113 arranged in the “12 o'clock position”, is currently receiving a segment 16. A further receiving dog 113 is located in the “8 o'clock position”, which dog is not carrying a segment 16 and therefore has a free lateral surface because it has just delivered a segment 16 to the depositing element 112. In this case, the removal device 111 is in a position in which it passes the depositing element 112 with a free zone 124 in the form of a free space, so that in this receiving position, a collision between the removal device 111 and the depositing element 112 is ruled out and/or the depositing element 112 with its parts can carry out movements with respect to the removal device 111.

In order to transfer the segment 16 from the receiving dog 113 located in the “4 o'clock position” in the receiving position of the removal device 111, the removal device 111 is decelerated during the further rotational movement until the removal device 111 with the receiving dog 113 previously arranged in the “4 o'clock position” is arranged in the “6 o'clock position” and passes through the transfer station XB, as can be seen in the right-hand representation in FIG. 4.

The transfer station XB is the point of the shortest distance between the lateral surface of the transferring receiving dog 113, i.e. a receiving surface 123, and the depositing element 112. Because the number of receiving dogs 113 is odd, the transfer station XB can be arranged in the “6 o'clock position” opposite the receiving station XA in the “12 o'clock position” without two of the receiving dogs 113 passing the receiving station XA and the transfer station XB at the same time. The position of the removal device 111 with the receiving dog 113 arranged in the “6 o'clock position” is also referred to as the transfer position of the removal device 111 within the meaning of the invention.

The removal device 111 was decelerated during this rotational movement until the removal device 111 in the transfer position is rotating at a much lower circumferential speed or even at a standstill for a very brief moment. In the transfer position of the removal device 111, the segment 16 is delivered from the receiving dog 113 arranged in the “6 o'clock position” to the depositing element 112, which is explained in more detail below. Because the receiving dog 113 is rotating at a much lower circumferential speed in this position, or ideally even at a standstill, the segment 16 is transferred with much lower transverse forces than would be possible without decelerating the removal device 111. In the event that the removal device 111 is at a standstill, the segment 16 is transferred to the depositing element 112 without any transverse forces, solely in a movement to the depositing element 112 in the direction of the surface normal of the segment 16. As a result, the segments 16 are subjected to the lowest possible transverse forces during the transfer and can therefore then be stacked to form a stack with a very high positional accuracy.

Furthermore, the third free receiving dog 113 is in the “10 o'clock position” in this position of the removal device 111, i.e. the transfer position at standstill and/or at the low rotational speed, and in the “12 o'clock position” at an angle of 60 degrees with respect to the receiving station XA of the transfer cylinder 5. Because the free receiving dog 113 must again have the circumferential speed of the segments 16 on the transfer cylinder 5 in the receiving position of the removal device 111, the removal device 111 is then accelerated again until the free receiving dog 113, which was previously in the “10 o'clock position”, passes through the receiving station XA in the “12 o'clock position” at the circumferential speed of the segments 16 fed on the transfer cylinder 5 and receives a segment 16.

The removal device 111 in the form of the rotary body driven to rotate with the three receiving dogs 113 arranged at an angle of 120 degrees with respect to one another is thus accelerated and decelerated in a repeating sequence, wherein the rotary body is decelerated and accelerated three times during one revolution corresponding to the number of receiving dogs 113. The removal device 111 can also have an even number of receiving dogs 113, wherein in this case the receiving station XA and the transfer station XB must be positioned differently, e.g. in the “12 o'clock position” and in the “4 o'clock position”, because due to the different requirements with regard to the movement states of the removal device 111 during the reception and transfer of the segments 14, it is not possible to transfer one segment 16 at the same time as receiving a second segment 16, i.e. two receiving dogs 113 cannot pass through the receiving station XA and the transfer station XB at the same time. It is therefore advantageous to provide an odd number of removal dogs 113 because the receiving station XA and the transfer station XB can thereby be arranged opposite one another, i.e. in the “12 o'clock position” and in the “6 o'clock position” and thus at an angle of 180 degrees with respect to one another, as can be seen in the two representations in FIG. 4. The movement of the removal device 111 is controlled in such a way that the removal device 111 is decelerated and accelerated overall without changing the distances between the receiving dogs 113. The removal device 111 is formed here by a rotary body driven to rotate in the form of cylinder, so that the receiving dogs 113 are in this case arranged at invariable angles to one another during the rotational movement. The receiving dogs 113 are arranged equidistant from each other at identical angles with respect to one another and are driven together with the base body of the removal device 111. The advantage of this solution is that the acceleration and deceleration of the segments 16 to the transfer station XB and receiving station XA is achieved solely by a single control of the movement of the removal device 111, while the receiving dogs 113 themselves do not perform an individualised controlled movement, but are decelerated and accelerated as an assembly. This allows the overall control and structural design to be simplified. In particular, the receiving dogs 113 do not require any separate movable mounting on the removal device 111. In this case, it is in particular advantageous to arrange the transfer station XB in the “6 o'clock position”, i.e. below the removal device 111, because the transfer of the segments 16 does not take place against gravity and is even supported thereby.

The depositing element 112 has a receptacle 115 which can be moved linearly by means of a lifting device 116, wherein the movement of the receptacle 115 is triggered by an activation of the lifting device 116 and is guided by means of a guidance device, e.g. a guide rod. The receptacle 115 can be moved linearly between a receiving position and a delivery position, wherein the receiving position of the receptacle 115 is arranged as close as possible to the transfer station XB of the segments 16, while the delivery position of the receptacle 115 corresponds to a more distant position of the receptacle 115 assigned to the discharge device 3.

Furthermore, the depositing element 112 has a depositing lever 117 having a comb-like structure having a plurality of fins 118 oriented parallel to one another, which are dimensioned in width and arrangement such that, during the rotation of the removal device 111, they engage in the gaps between the fins 118 of the receiving dogs 113 due to their position or by active movement, and in the transfer station XB passively or actively comb the segment 16 held thereon off the receiving dog 113. If the receiving dogs 113 are at a standstill in the transfer station XB, it is advantageous that the depositing lever 117 itself executes a movement with respect to the receiving dogs 113 and actively combs the segments 16 out of the lateral surfaces of the receiving dogs 113. In this case, the depositing lever 117 is driven to perform a periodic linear lifting movement by means of a drive device. In this case, when a receiving dog 113 moves into the transfer station XB, the depositing lever 117 with its fins enters the gaps between the fins of the receiving dog 113 under the segment 16 held thereon. To discharge the segment 16, the depositing lever 117 then executes a linear lifting movement in the radial direction of the removal device 111 and picks up the segment 16 in the direction of its surface normal. In this case, due to the direction of the discharge movement of the segment 16, the smallest possible forces act on the segment 16, and a particularly gentle discharge movement of the segment 16 can be realized. The linear lifting movement of the depositing lever 117 ends with the deposition of the segment 16 in the receptacle 115 of the depositing element 112. In this case, the stroke of the lifting movement of the depositing lever 117 is controlled such that the segment 16 is deposited in the receptacle 115 if possible with no falling movement and with the least possible compressive force. For this purpose, the stroke is controlled as a function of the increasing stack height of the segments 16 stacked in the receptacle 115 in that it decreases as the number of stacked segments 16 increases. Alternatively, after the deposition of a segment 16 the receptacle 115 can also be driven to perform a lifting movement by means of a linear drive device, wherein the stroke in this case corresponds at least to the thickness of the segment 16. This allows the stroke of the depositing lever 117 to be selected to be constant. However, it is preferred that the receptacle 115 in this case is moved away from the removal device 111 by a stroke corresponding to the thickness of the segment 16 plus a slight additional distance of, for example, one millimetre. In order to ensure that the segments 16 are always deposited at a constant distance from the stack surface which is as small as possible, the depositing lever is in this case driven to perform a lifting movement in which the stroke is increased by the additional distance of, in this case, ideally one millimetre each time a segment 16 is deposited. Due to the proposed solution, the receptacle 115 is additionally moved away from the removal device 111 by a factor corresponding to the number of stacked segments 16 multiplied by the additional distance, so that an additional free space is formed into which the transfer device 114, described in more detail below, can move without any further movement of the receptacle 115 being necessary. If the additional distance is 1 millimetre and the number of segments 16 in the stack is twenty, the receptacle is then moved an additional twenty millimetres away from the removal device 111, i.e. away from the transfer station XB, and the transfer device 114 can be moved to the transfer station XB to place the subsequent segments 16 without any further movement of the receptacle 115.

A vacuum channel system extends in the depositing lever 117. The vacuum channel system has a supply channel. A plurality of branch channels branch off from the supply channel. The branch channels are arranged to lead away from the supply channel and toward a free surface of the depositing lever 117.

A plurality of vacuum lines 120 are provided in the depositing lever 117, which can be seen in FIG. 7. The vacuum lines 120 terminate with their openings in the underside of the depositing lever 117 in a receiving surface provided thereon. In addition, the vacuum lines 120 are connected to an external, inherently flexible line of an external vacuum supply 121. The vacuum supply 121 with a negative pressure in the vacuum lines 120 of the depositing lever 117 is controlled such that the negative pressure is already present in the vacuum lines 120 when a segment 16 is fed into the transfer station XA via a receiving dog 113, and the segment 16 is still held on the receiving dog 113 via the negative pressure acting in the vacuum lines 122 of the receiving dog 113. In the receiving station XA, the depositing lever 117 comes into contact with the upper side of the segment 16 with its underside, which segment at this time is still being held via the same surface via the in the vacuum lines 122 of the receiving dog 113. The segment 16 is thus briefly held by the negative pressures acting in the vacuum lines 120, 122 of the receiving dog 113 and of the depositing lever 117 simultaneously and in the same direction, in this case toward its upper side. Only when the depositing lever 117 is holding the segment 16 via the negative pressure in its vacuum lines 120 is the negative pressure in the vacuum lines 122 of the receiving dog 113 switched off. In this case, the negative pressure in the vacuum lines 122 of the receiving dog 113 and the movement of the depositing lever 117 overlap, so that the segment 16 is pulled off the depositing lever 117 against the negative pressure still present in the vacuum lines 122 of the receiving dog 113. The segment 16 is thus permanently exposed to a suction force, first from the removal device 111 and then from the depositing lever 117. This completes the transfer of the segment 16 from the removal device 111 to the depositing lever 117, and the depositing lever 117 deposits the segment 16 into the receptacle 115 of the depositing element 112 in a linear lifting movement. In order for the depositing lever 117 to carry out the linear lifting movement and the segment 16 to still be held on the depositing lever 117 by a negative pressure, the vacuum lines 120 are connected to an external vacuum supply via a flexible line 121. Because of the flexible line, the vacuum supply can also be realized via the interface between the parts moving relative to each other. On its upper side facing the segment 16 to be transported away, the depositing lever 117 has a curved receiving surface, which is formed by the end faces of the fins of the depositing lever 117. The curvature of the surface corresponds to the curvature of the receiving surface 123 of the receiving dog 113, so that the fins of the depositing lever 117 and of the receiving dog 113 complement each other in the engaged position of the depositing lever 117 to form an enlarged, homogeneous, curved contact surface.

The receptacle 115 can also have vacuum lines which can be subjected to a negative pressure and which are arranged with their openings in such a way that, when a negative pressure is applied, they generate a suction force on the segments 16 to be received. The segments 16 can then be transferred in the transfer station XB by switching off the negative pressure in the vacuum lines of the receiving dog 113 arranged in the “6 o'clock position” and by the vacuum lines of the receptacle 115 sucking the segments 16 from the removal device 111 into the receptacle 115 of the depositing element 112, in addition to the above-described combing process by the depositing lever 117.

This process of delivering the segments 16 from the receiving dog 113 of the removal device 111 into the receptacle 115 of the depositing element 112 is repeated until a suitable sensor device detects that a predetermined height of the stack of segments 16 built up in the receptacle 115 has been exceeded or that a predetermined number of segments 16 stacked in the receptacle 115 has been reached. Depending on the signal from the sensor device, the lifting device 116 is then activated and the receptacle 115 with the stack of segments 16 is linearly moved to the discharge device 3, from the receiving position to the delivery position. In principle, the number of segments 16 fed in and the number of segments 16 discharged in previous ejection devices are also known in the machine controller of the production machine and the cell-stacking system, so that the lifting device 116 can also be activated when it is detected that the predetermined number of segments 16 has been reached, based on the number of stacked segments 16 known in the machine controller.

The depositing element 112 further has a transfer device 114 which can be moved from a ready position to a holding position and is arranged in the holding position during the movement of the receptacle 115 for transporting away the stacks and forms a temporary depository for depositing the segments 16, as can be seen in the left-hand representation in FIG. 4. The transfer device 114 provided allows the segments 16 to be deposited even when the receptacle 115 filled with the previously completed stack is moved from the removal device 111 to the delivery position for transferring the stack and is thus not available to receive the segments 16 in the transfer station XB. As a result, uninterrupted, i.e. continuous, delivery of the segments 16 from the removal device 111 can be made possible at the high stacking rate thereby made possible.

If the sensor device detects the target height of the stack and/or the target number of segments 16 in the stack of the receptacle 115, the transfer device 114 will be moved from the ready position to the holding position by utilizing the free space created due to the movement of the receptacle 115 and/or due to the free spaces present between the receiving dogs 113. In this case, the transfer device 114 is moved with its setdown surface into an intermediate space between the receptacle 115 and/or the stack of segments 16 built up therein and the imaginary outer diameter of the receiving dog 113, so that the next segment 16 is not deposited from the next receiving dog 113 on the stack in the receptacle 115 but instead on the setdown surface of the transfer device 114. The transfer device 114 then forms an intermediate receptacle in the holding position for depositing the segments 16. After the transfer device 114 has been arranged with its setdown surface in the holding position, the lifting device 116 is activated and the receptacle 115 with the stack of segments 16 is moved in a linear movement vertically downward from the receiving position into a delivery position assigned to the discharge device 3. In this case, the receptacle 115 is moved linearly in the direction of the surface normal of the segments 16 stacked to form the stack, so that during this movement as few transverse forces as possible act on the stack and the segments 16. As a result, it can be ensured that the segments 16 stacked with positional accuracy individually and the precisely positioned stack as a whole do not shift sideways. If this makes sense, the segments 16 stacked one on top of the other to form the stack can also be additionally fastened to one another by means of a tape.

In order for the segments 16 to be deposited on the transfer device 114 only when the receptacle 115 is not arranged in the transfer station XB, the transfer device 114 is moved from the holding position back to the ready position shown in the right-hand representation in FIG. 4 as soon as the receptacle 115 has been moved back to the transfer station XB.

In this case, the receptacle 115 and the transfer device 114 each have a setdown surface which is formed by the surfaces of a plurality of identical fins 118 arranged parallel and equidistant from one another. The transfer device 114 and the receptacle 115 engage with each other with their fins 118 during their movements for transferring the stacks of segments 16. Thus, after the stack is delivered to the discharge device 3, the receptacle 115 is moved back to the receiving position and its fins 118 engage between the fins 118 of the transfer device 114. In this position, the receptacle 115 and the transfer device 114 briefly form a common setdown surface for the stack of segments 16 to be stacked. The transfer device 114 is then moved from the holding position back to the ready position in that it moves laterally parallel to the fins 118 and disengages from the fins 118 of the receptacle 115. The stack is then exclusively supported by the setdown surface of the receptacle 115 and the further segments 16 are stacked on the stack held in the receptacle 115 until the intended stack height of the stack is reached, and the process is repeated.

Due to the proposed design of the setdown surfaces of the receptacle 115 and of the transfer device 114 with the fins 118, the receptacle 115 can be moved back to the receiving position after the stack has been delivered without colliding with the transfer device 114 and/or without disturbing the deposition of the segments 16 onto the transfer device 114 which is currently taking place. Furthermore, the transfer device 114 can thereby be moved from the holding position back to the ready position without the stack losing its support. The fins of the receiving dogs 113, of the transfer device 114 and of the receptacle 115 each form a profiled surface having a structure which allows for mutual engagement of the transfer device 114 with the receiving dog 113 and the receptacle 115. For this purpose, the fins of one part are arranged to correspond to the intermediate spaces of the other part. To ensure that the engagement movement can be carried out reliably, the intermediate spaces and the fins are dimensioned in such a way that they mesh with a certain amount of play. Furthermore, the fins and the intermediate spaces are aligned in such a way that they are aligned in the direction of the engaging movement of the parts.

In the present exemplary embodiment, the removal device 111 is formed by a rotary body which can be driven to rotate and has at least two carrier zones which are arranged at a distance from one another in the direction of rotation (and fixed in the direction of rotation) and extend in the direction of rotation over a length Y for receiving the segments 16 at the receiving station XA. The carrier zones are formed here by the receiving surfaces 123 of the receiving dogs 113. Free zones 124 extending over a length Z in the direction of rotation are provided between the carrier zones, which free zones, in the present embodiment, are each formed by a recess extending radially inward and thus form a free space. The carrier zones are specifically designed to receive one segment 16 each, while the free zones are not designed to receive segments 16 and merely form deliberately unused intermediate zones between the carrier zones, which intermediate zones are important for realizing the different movement states of the removal device 111 and for the reception and transfer of the segments 16. For this purpose, the carrier zones and the free zones 124 are arranged such that the removal device 111 passes the depositing element 112 with a free zone 124 in a receiving phase at the receiving station XA during which a segment 16 is received by a carrier zone.

The free zones 124 are realized here by recesses. Alternatively, however, they can in general also be formed by passive surfaces of the rotary body, which passive surfaces do not have vacuum lines and are therefore not designed to receive segments 16. The free zones are characterized by the fact that they do not carry any segments 16 and therefore do not deliver any segments 16 in the transfer station XB. The removal device 111 does not therefore have to meet special movement conditions in the receiving phase in which it passes the transfer station XB with the free zones and its movement behaviour can be designed solely for receiving the segment 16 in the receiving station XA.

The carrier zones and the free zones 124 are arranged such that while a carrier zone is passing the receiving station XA, a free zone passes the transfer station XB, and while a carrier zone is aligned with the transfer station XB, a free zone is aligned with the receiving station XA. In this case, the free zones 124 can have a greater length Z in the circumferential direction of the rotary body than the carrier zones, so that the angles of rotation at which the free zones 124 pass the transfer station XB and the receiving station XA are greater than the angles of rotation at which the carrier zones pass the transfer station XB and the receiving station XA. As a result, the angles of rotation available for the acceleration and deceleration of the removal device 111 are greater than the angles of rotation required to receive and transfer the segments 16. Due to the greater angles of rotation, the maximum acceleration and maximum deceleration for switching between the two predetermined speeds can be reduced. In this case, the free zone 124 has a length Z spanning the receiving station XA and the transfer station XB.

In this case, the length Y of one or each carrier zone can be less than, equal to or greater than the length Z of one or each free zone 124. Furthermore, the lengths Z of the free zones 124 between the carrier zones can also be the same or different, whereby the advantages described above can be achieved.

Cylinders having a cylindrical lateral surface can come into consideration as rotary bodies, in which cylinders the carrier zones and the free zones 124 are formed by zones which are deliberately designed to carry or receive segments 16, while the free zones are not configured for this purpose and can also be referred to as passive zones. Furthermore, all bodies, which receive the segments 16 in a rotational movement in the receiving station XA, transport them further to the transfer station XB by means of the rotational movement and deliver them there as described above, can also be considered as rotary bodies.

The rotary body can also be designed as a rotor having a plurality of rotor arms, wherein one or each rotor arm can have a receiving surface at its free ends. Furthermore, one or each rotor arm can be provided with vacuum channels which can open into the free ends of the rotor arms and in particular into the receiving surfaces arranged thereon. The rotor arms of the rotor are fixedly positioned relative to one another in the direction of the rotation path of the rotor, in particular fixed in their distance relative to one another in the direction of the rotation path, in particular unchangeable in their distance in the direction of the rotation path. The discharge device 3 has a plurality of individually movable transport receptacles 119, which also have a setdown surface having identically designed fins 118 arranged parallel and equidistant from one another, the distances between which correspond at least to the width of the fins 118 of the receptacle 115. As a result, the receptacle 115 can, in the deposition position, dip with its fins 118 between the fins 118 of the transport receptacle 119 and deposit the stack on the setdown surface of the transport receptacle 119. The individually movable transport receptacles are used for transporting the stacks away for further processing. Because the segments 16 and stacks are checked for compliance with predetermined quality criteria by means of one or more sensor devices during the preceding transport and/or stacking process and are outwardly transferred from the production process if the quality criteria are not met, the stacking processes and the frequency of the stacks to be transported away from the receptacles 115 can vary. This change in the transport frequency of the stacks to be transported away can be taken into account by the individual mobility of the transport receptacles 119 in conjunction with a corresponding control system.

The length Y of one or each carrier zone extending in the direction of rotation is greater than or equal to 20 mm, 50 mm, 60 mm, 90 mm or 100 mm. The length Y of one or each carrier zone extending in the direction of rotation is less than or equal to 200 mm, 180 mm, 150 mm, 120 mm, 100 mm, 80 mm or 60 mm. The extension of one or each carrier zone transverse to the length Y is greater than or equal to 40 mm, 50 mm, 60 mm, 80 mm, 90 mm, 100 mm, 150 mm, 180 mm or 300 mm. The extension of one or each carrier zone transverse to the length Y is less than or equal to 400 mm, 350 mm, 300 mm, 250 mm, 200 mm, 150 mm, 130 mm, 120 mm, 110 mm, 100 mm, 90 mm, 80 mm, 50 mm or 40 mm.

Individual separator sheets or monocells having separator sheets come into consideration as segments 16, wherein one or each separator sheet has a thickness of 8 to 25 μm, preferably 10 to 15 μm. With such thin separator sheets, very high specific energies and energy densities can be achieved while maintaining a very compact structure. Furthermore, the cell-stacking system 1 can be used to stack anodes and/or cathodes and/or segments 16 or monocells having one anode, one cathode and two separator sheets having an electrode area of 2×4 cm for producing very small cells, in particular very small pouch cells. The cell-stacking system 1 can also be used to stack anodes and/or cathodes and/or segments 16 or monocells with one anode, one cathode and two separator sheets having an electrode area of 15×40 cm for producing larger-area cells. The areas of the receiving surfaces 123 of the receiving dogs 113 are dimensioned such that the segments 16 or the monocells can be received and transported over their entire area or part of their area. Exemplary dimensions for the anodes and/or cathodes are in the range from 100×50 mm to 200×100 mm, in particular from 120×60 mm to 180×90 mm with electrode areas from 800 mm² to 80 000 mm², in particular in the range from 1200 mm² to 60 000 mm² or 1800 mm² to 36 000 mm².

The fins 118 preferably form with their surfaces a surface portion of 30 to 70% of the surface of the receiving surfaces 123 of the receiving dogs 113, so that a segment 16 held thereon lies flat on a receiving surface 123 with an area of 30 to 70% of its surface. The segment 16 can be fastened to the receiving surfaces 123 via the negative pressure in the vacuum lines 122. The proposed surface area is preferred in that it allows a gentle reception and a gentle transport of the segments 16 while at the same time ensuring positionally accurate fastening of the segments 16, and allows the depositing lever 117 to engage through the intermediate spaces between the fins 118 with a lifting movement thereby made possible.

An important and independently inventive aspect of the present invention further consists of a sub-device of or in a cell-stacking system described above and a sub-method for producing cell stacks in a cell-stacking system described above, according to claim 35 and claim 39, respectively.

In this way, it is possible to further process a high stream of segments 16, for example cut on-line from a four-ply continuous web EG, immediately after they have been cut, wherein the cut segments 16 are practically never released and can be continuously provided for stacking. In a certain sense, the segments 16 are no longer released, which makes it possible to maintain the position of the segments 16 and their orientation in a processing line/chain and to use them to control further subsequent processing units. Repeated alignment processes, such as those typically required when temporarily depositing segments 16, interrupting the material flow and then resuming it, can be reduced or even largely or completely eliminated. Alignment can be carried out very effectively by aligning the web from which the segments 16 are cut. If necessary, corrections can also be made to the positioning and/or alignment of the segments in the feed device, the conveyor unit F1 and/or the conveyor unit F2.

The supplied segments 16 of energy cells in a number A per unit of time are cleverly split into a number B per unit of time and a number C per unit of time. The number B per unit of time can, in a certain way, be advantageously further transported and virtually passed through and separated from the number A, resulting in the number C already being significantly reduced compared to the number A. This makes the number C easier to stack in an orderly and precise manner without hindering the material flow. The number B is then also significantly reduced compared to the number A and is easier to stack in an orderly and precise manner. In a certain way, a continuous, delay-free feed of divided partial streams to a cell-stacking device 7 is made possible. If the cell-stacking device 7 is equipped with corresponding entries for the partial streams, the stacking can in a certain way be carried out in parallel, allowing high throughput rates to be achieved. A continuous web EG of uncut segments 16 can be fed at high speed and the segments 16 cut therefrom can be further processed and stacked on-line. A high stream of segments 16 can be further transported reliably and effectively in an orderly manner, virtually without stopping or interruption, and can be advantageously divided into partial streams.

A stream of segments 16 with a number A per unit of time, for example cut on-line from a continuous web EG, can be split, for example, in such a way that every second segment 16 is removed from the stream, and a stream of segments 16 with the number B per unit of time is formed from the removed second segments 16, and a stream of segments 16 with the number C per unit of time is formed from the remaining segments 16. In the stream of segments 16 with the number B, the distance between two segments 16 can be greater than or approximately equal to the length of a segment 16. In the stream of segments 16 with the number C, the distance between two segments 16 can be greater than or approximately equal to the length of a segment 16. A distance formed in the stream of segments 16 with the number B between two consecutive segments 16 makes it possible to provide a sequence of segments 16 during further processing, in which the distance and an associated time interval during conveying of the stream of segments 16 can be used to access a segment 16. For example, one or more removal devices 111 of a cell-stacking unit 11 can be given sufficient time in the time interval between the end of a first conveyed segment 16 and the beginning of a second conveyed segment 16 to be moved back to the receiving position, in particular from a delivery or waiting position. The process of splitting is somewhat similar to opening a zipper, whereby when closed all the elements lie next to each other with virtually no gap, and after opening they have approximately the distance of one element between them. However, it is advantageous for the invention if, in contrast to the zipper comparison, the segments 16 have a certain distance in the stream with the number A per unit of time, in particular if they are not edge to edge or end to end. The splitting can also be imagined as follows: in the stream of segments 16 with the number A, the segments 16 of the stream with the number B and the segments 16 of the stream with the number C lie alternatingly one after the other, for example “yellow” and “red” segments 16. In a delivery area, for example G1, the stream is split into segments 16 with the number A, and the segments 16 of the stream with the number B and the segments 16 of the stream with the number C are transferred or allowed to pass according to their alternating sequence. Taking up the colour example, a stream of “yellow” segments 16 with the number B per unit of time and a stream of “red” segments 16 with the number C would then be generated. For both streams “B” and “C”, the segments 16 would each be at a distance from each other that is greater than or approximately equal to the length of a segment 16. In this embodiment, the transport speed of the streams of segments 16 with the number A per unit of time, the number B per unit of time and the number C per unit of time can be kept at least approximately the same. Advantageously, distances between the segments 16 in the streams “B” and “C” can be achieved in a simple manner without having to change the position of the segments 16 in the streams “B” and/or “C”, which ensures particularly gentle handling of the segments 16 and allows high throughput rates.

The splitting of the segment stream of the number A coming from the feed device 2 into the two partial streams with the numbers B and C allows for an increase in the number A of segments 16 supplied per unit of time, given a predetermined and limited stacking capacity of a cell-stacking unit 11, in that the number A of supplied segments 16 is stacked in two separate and parallel operating cell-stacking units 11 at a correspondingly lower stacking rate.

If the conveying rate of the supplied segments 16, i.e. the number A, is to be further increased, the incoming stream of segments 16 in the number A can be divided into further partial streams of the numbers D, E, F, etc. and then stacked in parallel in further cell-stacking units 11. The basic idea of splitting the inflow of segments 16 between a plurality of cell-stacking units 11 thus allows for a significantly higher conveying capacity of the segments 16 with simultaneously positionally accurate stacking of the segments 16 in the cell-stacking units 11 because the stacking speed can be designed to be correspondingly lower than the feed rate of the segments 16 via the feed device 2 to achieve positionally accurate stacking.

In this case, the number B of segments 16 which are fed into the first transfer area G1 of the second conveyor unit F2 is greater than the number C of segments 16 which are discharged into the second delivery area G2. During the conveying process, the segments 16 are subjected to various quality checks and checks to determine whether the parts of the segments 16 are correctly arranged with respect to one another, such as contact tabs, fastening devices, etc., wherein if non-compliance with the quality specifications is detected, the segments 16 found to be “not OK” are outwardly transferred from the conveying process. This results in the number of segments 16 finally stacked always being slightly less than the number of segments 16 fed in. The segments 16 discharged in the second delivery area G2 have already been completely checked, e.g. also by means of a sensor device arranged between the first delivery area G1 and the second delivery area G2, so that the number C of the discharged segments 16 is completely stacked without further segments 16 being outwardly transferred. However, the segments 16 transferred in the second delivery area G2 subsequently pass along a further transport path, so that they may still shift slightly or be affected in some other way, such that further tests and associated outward transfers of the segments 16 may subsequently be necessary. It therefore makes sense to design the number B of segments 16 transferred to the second conveyor unit F2 in the first delivery area G1 to be larger than the number C of segments 16 discharged in the second delivery area G2.

Furthermore, it is advantageous if the number B of segments corresponds to a multiple of the number C. In this case, a structurally simple design with correspondingly simple stacking can be achieved by providing a plurality of identical cell-stacking units 11. In the present case, four cell-stacking units 11 are provided, as can be seen in FIG. 1, such that the number B of segments 16 transferred in the first delivery area G1 corresponds to three times the number C of segments 16 transferred in the second delivery area G2. The production machine shown in FIG. 1 can be operated by the proposed sub-device and/or the proposed sub-method at a high conveying rate of the segments 16 in the feed device 2 and simultaneous positionally accurate stacking of the segments 16 in the cell-stacking units 11 because the stacking rate of the segments 16 in the cell-stacking units 11 is considerably lower than the feed rate of the segments 16 in the feed device 2 due to the solution according to the invention. If the feed rate of the segments 16 in the feed device 2 corresponds to the number A, e.g. 400 segments 16 per unit of time, e.g. per minute, the number C in this case would be 100 segments per minute and the number B would be 300 segments per minute. In this case, the reduction in segments 16 caused by removals due to quality defects is not taken into account here.

The proposed sub-device can be further improved as desired with the features of the proposed cell-stacking system 1, wherein in particular the parallel arrangement of the cell-stacking units 11 and their assignment to the four transfer cylinders 5 is important because this makes possible a positionally accurate stacking of the product streams of the segments 16 divided by the sub-device. In the same way, the proposed sub-method can also be further improved by combining it with the features of the proposed method for controlling a cell-stacking system 1 because the proposed method contains essential suggestions as to how the cell-stacking system 1 can be better controlled for stacking the partial streams formed by the sub-method.

### LIST OF REFERENCE SIGNS

1 Cell-stacking system
2 Feed device
3 Discharge device
4 Cutting device
5 Transfer cylinder
6 Reversing cylinder
7 Cell-stacking device
11 Cell-stacking unit
16 Segment
111 Removal device
112 Depositing element
113 Receiving dog
114 Transfer device
115 Receptacle
116 Lifting device
117 Depositing lever
118 Fins
119 Transport receptacle
120 Vacuum line
121 Vacuum supply
122 Vacuum line
123 Receiving surface
124 Free zone
A,B,C,D,E,F Number
E1-E4 Continuous webs
EG Four-ply continuous web
F1 First conveyor unit
F2 Second conveyor unit
G1 First delivery area
G2 Second delivery area
XA Receiving station
XB Transfer station
Y Length
Z Length

1. A cell-stacking system for stacking segments of energy cells, said system comprising:
a feed device which continuously feeds the segments at a feed speed, and
at least one cell-stacking unit which directly or indirectly receives the segments supplied by the feed device and stacks them one on top of the other to form stacks, wherein
the cell-stacking unit has at least one removal device and one depositing element, wherein
the removal device is driven to perform a repeating alternating movement of an acceleration and a deceleration, and
the removal device receives the segments at the feed speed from the feed device and transfers said segments in a decelerated movement or at a standstill to the depositing element.

2. The cell-stacking system according to claim 1, wherein
the removal device is formed by a rotatably driven rotary body, and the repeating alternating movement of an acceleration and a deceleration is formed by an accelerated and decelerated rotary movement of the rotary body.

3. The cell-stacking system according to claim 2, wherein
the rotary body has at least two receiving dogs arranged at equal angles to one another for receiving the segments, and
the rotary body is decelerated and accelerated during one revolution according to the number of receiving dogs.

4. The cell-stacking system according to claim 3, wherein
the number of receiving dogs is odd.

5. The cell-stacking system according to claim 3, wherein
the receiving dogs each have a circular-arcuate receiving surface in the cross-section of the rotary body, and
the receiving surfaces of the receiving dogs are arranged on the same diameter in cross-section.

6. The cell-stacking system according to claim 1, wherein
the depositing element has a linearly movable receptacle which transports the stacks away from the removal device in the direction of a surface normal of the segments.

7. The cell-stacking system according to claim 6, wherein
the depositing element has a lifting device which, when activated, moves the receptacle via a linear guidance device.

8. The cell-stacking system according to claim 7, wherein
at least one sensor device is provided in the region of the lifting device, which sensor device detects a property of the stack or the receptacle.

9. The cell-stacking system according to claim 6, wherein
the depositing element has a transfer device which can be moved from a ready position to a holding position, is arranged in the holding position during the movement of the receptacle for transporting away the stacks and forms a temporary depository for depositing the segments.

10. The cell-stacking system according to claim 6, wherein
the receptacle and the transfer device each have a setdown surface which is formed by the surfaces of profiles consisting of fins and intermediate spaces arranged therebetween, and wherein
the transfer device and the receptacle engage with their fins in the intermediate spaces of the other part during their movements for transferring the stacks of segments.

11. The cell-stacking system according to claim 1, wherein
a discharge device is provided with a plurality of individually movable transport receptacles into which the depositing element deposits the stacks.

12. The cell-stacking system according to claim 1, wherein
the removal device and/or the receptacle of the depositing element has one or more vacuum lines which can be subjected to a negative pressure and which, by applying a negative pressure, support the reception of the segments by the removal device from the feed device and/or by the depositing element from the removal device and the transport on the removal device.

13. The cell-stacking system according to claim 1, wherein
the depositing element has a depositing lever which removes the segments from the removal device and feeds them to the depositing element.

14. The cell-stacking system according to claim 13, wherein
the depositing lever is driven by a drive device to perform a periodic discharge movement from the removal device.

15. The cell-stacking system according to claim 14, wherein
the discharge movement is formed by a linear lifting movement.

16. A cell-stacking system for stacking segments of energy cells, said system comprising:
a cell-stacking device and
a feed device which feeds the segments to the cell-stacking device, wherein
at least one cell-stacking unit is arranged in the cell-stacking device, which cell-stacking unit stacks the segments one on top of the other to form stacks, wherein
the cell-stacking unit has at least one removal device and a depositing element arranged at a transfer station, and
the removal device comprises a rotary body which can be driven to rotate and has at least two carrier zones which are arranged at a distance from one another in the direction of rotation (and fixed in the direction of rotation) and extend in the direction of rotation over a length Y for receiving the segments at a receiving station, wherein
free zones extending over a length Z in the direction of rotation are provided between the carrier zones, and
the carrier zones and the free zones are arranged such that the removal device passes the depositing element with a free zone in a receiving phase at the receiving station during which a segment is received by a carrier zone.

17. The cell-stacking system according to claim 16, wherein
the length Y of one or each carrier zone is less than, equal to or greater than the length Z of one or each free zone.

18. The cell-stacking system according to claim 16, wherein
the lengths Z of the free zones between the carrier zones are equal or different.

19. The cell-stacking system according to claim 16, wherein
one or each carrier zone has a receiving surface.

20. The cell-stacking system according to claim 16, wherein
one or each free zone is formed by a radially inwardly extending recess on the rotary body.

21. The cell-stacking system according to claim 16, wherein
one or each free zone has a boundary offset radially inward relative to one or each carrier zone.

22. (canceled)

23. A method for controlling a cell-stacking system for stacking segments of energy cells, comprising:
a feed device which continuously feeds the segments at a feed speed, and
at least one cell-stacking unit which receives the segments from the feed device and stacks them one on top of the other to form stacks, wherein
the cell-stacking unit has at least one removal device and one depositing element, and wherein
the removal device has a controllable drive device which is controlled such that the removal device is accelerated to receive the segments from the feed device and is decelerated to transfer the segments to the depositing element.

24. The method according to claim 23, wherein
the removal device is formed by a cylinder driven to rotate by the drive device, and
the drive device controls the rotary movement of the cylinder in such a way that the cylinder receives the segments from the feed device in a rotary movement and transfers them to the depositing element at a standstill or in a decelerated rotary movement.

25. The method according to claim 23, wherein
the depositing element has a linearly movable receptacle, and
the linearly movable receptacle is moved from a receiving position to a delivery position when a sensor device detects that a predetermined stack height of the stack in the receptacle has been reached.

26. The method according to claim 23, wherein
a transfer device is provided which is moved from a ready position to a holding position by means of a controllable drive device in order to receive the segments.

27. The method according to claim 26, wherein
the transfer device is moved from the ready position to the holding position between the transfer of two segments.

28. The method according to claim 26, wherein
the transfer device is moved from the holding position to the ready position after the movable receptacle has been moved from the delivery position to the receiving position.

29. The method according to claim 26, wherein
the movement of the transfer device is controlled as a function of the movement and/or the position of the receptacle.

30. The method according to claim 26, wherein
the receptacle and the transfer device each have a setdown surface which is formed by the surfaces of a plurality of fins arranged parallel and equidistant from one another, and
the transfer device and the receptacle engage with each other using their fins during their movements for transferring the stacks of segments.

31. The method according to claim 23, wherein
a depositing lever is provided which receives the segments from the removal device in a removal movement and feeds them to the depositing element.

32. The method according to claim 31, wherein
the depositing lever is driven by a drive device to perform a periodic discharge movement from the removal device.

33. The method according to claim 31, wherein
the removal device and the depositing lever each have vacuum lines which hold the segments by applying a negative pressure to the removal device and to the storage lever, and
the negative pressure in the vacuum lines of the removal device and in the vacuum lines of the depositing lever for transferring the segments is controlled in an overlapping manner.

34. The method according to claim 23, wherein
the discharge movement is formed by a linear lifting movement, and
the stroke of the lifting movement is controlled as a function of the stack height of the segments in the receptacle and/or the number of segments stacked in the receptacle.

35. A sub-device of, or in, a cell-stacking system for segments of energy cells according to claim 1, wherein
the feed device is designed and configured to feed segments of energy cells in a number A per unit of time,
a first conveyor unit for segments is provided, which first conveyor unit is arranged downstream of the feed device,
a second conveyor unit for segments is provided, which second conveyor unit is arranged downstream of the first conveyor unit, wherein
the first conveyor unit is designed and arranged to receive the number A per unit of time of the segments from the feed device and to transport a number B per unit of time of the segments to a first delivery area and a number C per unit of time of the segments to a second delivery area, wherein
the number B per unit of time of the segments is provided so as to be transportable in the direction of the second conveyor unit and transferable to the second conveyor unit in the delivery area, and wherein
the number C per unit of time of the segments in the second delivery area is provided so as to be transferable to a cell-stacking device, or to a cell-stacking unit, or to one or more removal devices of a cell-stacking device, and
the sum of the number B per unit time of the segments and the number C per unit time of the segments is less than or equal to the number A per unit time of the segments.

36. The sub-device according to claim 35, wherein
the second conveyor unit is designed as a rotationally drivable conveyor unit, in the form of a transfer cylinder or as an operatively connected combination of a first rotationally drivable conveyor unit in the form of a reversing cylinder and a second rotationally drivable conveyor unit in the form of a transfer cylinder.

37. The sub-device according to claim 35, wherein
the number C is less than the number B.

38. The sub-device according to claim 35, wherein
the number B is a multiple of the number C.

39. A sub-method for producing cell stacks in a cell-stacking system for segments of energy cells according to claim 1, wherein
a number A per unit of time of segments is fed by means of the feed device, which is designed and configured to feed segments of energy cells in a number A per unit of time,
a first conveyor unit for segments, which is arranged downstream of the feed device, conveys segments,
a second conveyor unit for segments, which is arranged downstream of the first conveyor unit, conveys segments,
wherein
the first conveyor unit receives the number A per unit of time of the segments from the feed device and transports a number B per unit of time of the segments to a first delivery area and a number C per unit of time of the segments to a second delivery area, wherein
the number B per unit of time of the segments is transported in the direction of the second conveyor unit and transferred to the second conveyor unit in the first delivery area, and wherein
the number C per unit of time of the segments is transferred in the second delivery area to a cell-stacking device, or to a cell-stacking unit, or to one or more removal devices of a cell-stacking device, and
the sum of the number B per unit time of the segments and the number C per unit time of the segments is less than or equal to the number A per unit time of the segments.

40. The sub-method according to claim 39, wherein
the second conveyor unit is operated as a rotationally drivable conveyor unit in the form of a transfer cylinder or as an operatively connected combination of a first rotationally drivable conveyor unit in the form of a reversing cylinder, and a second rotationally drivable conveyor unit in the form of a transfer cylinder.

41. The sub-method according to claim 39, wherein
the number C is less than the number B.

42. The sub-method according to claim 39, wherein
the number B is a multiple of the number C.
